(19) United States
(12) Patent Application Publication
(10) Pub. No.: US 2007/0266162 A1
(43) Pub. Date: Nov. 15, 2007

(54) Session initiation protocol redirection for process recycling

(75) Inventors: Amit Kumar Dutta, Seattle, WA (US); Sridhar Sundararaman, Bellevue, WA (US); Srinivasa Manda, Sammamish, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/400,040

(22) Filed: Apr. 7, 2006

Related U.S. Application Data
(60) Provisional application No. 60/748,362, filed on Dec. 7, 2005.

(51) Int. Cl. G06F 15/16

(52) U.S. Cl. 709/228

(57) ABSTRACT

Fault tolerant process recycling in unified messaging software applications implementing application layer signaling protocols. A manager process redirects incoming calls to available worker processes using a redirect method of the application layer signaling protocols. The redirection occurs independent of the network connection details of each of the worker processes.

### CROSS-REFERENCE TO RELATED APPLICATION

This application claims the benefit of U.S. Provisional Application No. 60/748,362, filed Dec. 7, 2005, herein incorporated by reference in its entirety.

### BACKGROUND

Developing a fault tolerant network design is essential in today's competitive market and in developing real-time and user-interactive applications such as unified messaging systems. Unified messaging systems at least require reliability and load balancing at the hardware level along with reliability at the software level. Reliability and load balancing at the hardware level are typically implemented by Internet Protocol private branch exchanges (IP-PBXs) and media gateways employing the use of, for example, domain name server service records (DNS SRV) and NPATR records as described in the Internet Engineering Task Force (IETF) RFC 3263, the entire disclosure of which is incorporated herein by reference. Other systems use session initiation protocol (SIP) proxies or SIP-aware network load balancers to distribute traffic and also achieve fault-tolerance. SIP, as described in the Internet Engineering Task Force (IETF) RFC 3261, the entire disclosure of which is incorporated herein by reference, is an application-layer control (signaling) protocol for creating, modifying, and terminating sessions with one or more participants. These sessions include Internet telephone calls, multimedia distribution, and multimedia conferences.

Reliability at the software level is typically implemented by using a hot/cold standby (or hot-swap) approach whereby two redundant copies of the same process are kept running. Control switches from one process to the other based on need or time to implement process recycling. For SIP-based software applications, however, these existing implementations are ineffective at least because the SIP-based software applications typically do not have control over the transport sockets (e.g., transmission control protocol/universal datagram protocol) carrying the SIP data for duplication across the processes. Further, SIP, like other real-time control protocols, has inherent timeouts and existing implementations are not fast enough to avoid timeouts. Further, once the SIP call is established, the media packets are transmitted using dynamically assigned ports such as in the real-time transfer protocol (RTP) and the real-time transport control protocol (RTCP). Existing systems fail to initiate the recycling process at the SIP call establishment phase (e.g., before any media packets are transmitted).

### SUMMARY

Embodiments of the invention implement fault tolerant process recycling in unified messaging applications based on application layer signaling protocols. At runtime, one or more unified messaging worker processes capable of servicing incoming calls are identified. In an embodiment, the invention uses a redirect method of the signaling protocol to redirect incoming calls from a caller to one of the unified messaging worker processes based on availability of the worker processes and other factors. In this manner, applications implement fault tolerant process recycling without maintaining connection parameters such as call mappings or socket level details of each worker process.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is an exemplary block diagram illustrating a high level design for process recycling in a unified messaging application.

FIG. 2 is an exemplary flow chart illustrating operation of a unified messaging server in one embodiment of the invention.

Corresponding reference characters indicate corresponding parts throughout the drawings.

### DETAILED DESCRIPTION

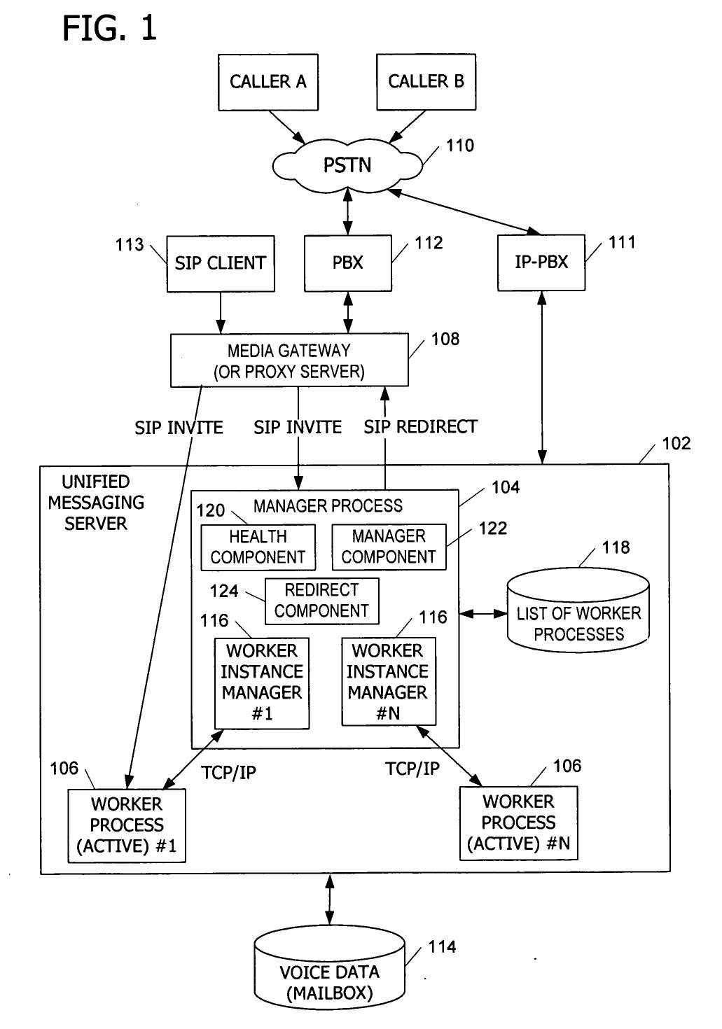

As illustrated in the exemplary embodiment of FIG. 1, aspects of the invention implement fault tolerant process recycling in unified messaging (UM) applications based on application layer signaling protocols. UM applications handle call forwarding, voice mail, etc. While embodiments of the invention may be described in the context of a UM system, aspects of the invention are not limited to UM systems. Further, while embodiments of the invention may be described herein with reference to the session initiation protocol (SIP), aspects of the invention are operable with any application layer signaling protocol. SIP, as described in IETF RFC 3261, the entire disclosure of which is incorporated herein by reference, provides proxy and redirect functions. As shown in the embodiment of FIG. 1 in which the application layer signaling protocol is SIP, a UM server 102 uses the SIP REDIRECT mechanism to redirect incoming calls to available processes without maintaining call mappings or network socket tables. The UM server 102 in FIG. 1 includes, but is not limited to, any application written on top of an application layer signaling protocol. As such, the low-level details of the network sockets are abstracted from the UM server 102 during process recycling. Process recycling is implemented via a manager process 104 that controls one or more worker processes 106 such as worker process #1 through worker process #N. The manager process 104 monitors the health of the worker processes 106 and stops/restarts the worker processes 106 as needed. Process recycling provides efficient monitoring of resources, better availability of overall service, and nearly uninterrupted service.

Typical non-SIP-based networking applications implement a hot/warm standby procedure with a manager process such as manager process 104 handing new connections to the currently active worker process (e.g., worker process 106) by duplicating the network socket handle and passing the duplicated network socket handle to the active worker process 106. SIP-based networking applications, however, have a stack that is written on top of a conventional transmission control protocol/universal datagram protocol (TCP/UDP) stack. As such, the low level socket details are abstracted or hidden from the SIP-based networking application. Thus, the SIP applications running at the highest layer have no control over the actual network sockets to switch control between the manager process 104 and active worker processes 106. With aspects of the invention, however, the SIP REDIRECT mechanism effectively enables the SIP applications (e.g., manager process 104) to implement process recycling independent of the network connections associated with each of the worker processes 106. The TCP/UDP stack maintains the network connection details of the worker processes 106.

Referring again to FIG. 1, the high level design of the process recycler of one embodiment of the invention is illustrated. The UM server 102 communicates with the media gateway 108 over SIP for signaling and the real-time transport protocol (RTP) for carrying media content such as voice over the Internet Protocol (VOIP). The Real-time Transport Protocol (RTP), as described in the IETF RFC 1889, the entire disclosure of which is incorporated herein by reference, provides end-to-end network transport functions suitable for applications transmitting real-time data, such as audio, video or simulation data, over multicast or unicast network services.

In the example of FIG. 1, Caller A and Caller B communicate with a public switched telephone network (PSTN) 110. For example, Caller A may call Caller B through the PSTN 110. Caller A and Caller B may include, for example, one or more of the following: a user, a client, an application program, and an operating system. The PSTN 110 is connected to a private branch exchange (PBX) 112. The media gateway 108 communicates with the PBX 112 and an SIP client 113 over T1, analog, and/or digital protocols. The UM server 102 communicates with the media gateway 108. The UM server 102 has access to, for example, voice data 114 such as a caller's voice mail box. In another embodiment, the PSTN 110 connects to the UM server 102 via an Internet Protocol Private Branch eXchange (IP-PBX) 111 (e.g., supporting VOIP).

The UM server 102 has the central manager process 104 that maintains worker instance managers 116 to maintain, monitor, or otherwise manage the worker processes 106 to, for example, implement fault tolerance, high availability, reduced timeouts, speed, and efficiency. As such, there are one or more active and passive worker processes 106. In one embodiment, the manager process 104 stores a list of the worker processes 106 in a memory area 118. Each of the worker processes 106 has connection parameters associated therewith. Connection parameters may include, for example, a port number, network address, socket number, and machine name. The manager process 104 and worker processes 106 exchange health monitoring and other control messages over a private transmission control protocol (TCP) channel. In one embodiment, the UM server 102 (or UM application) executes on a first computing device while one or more of the worker processes 106 execute on a second computing device.

The UM server 102 also stores one or more computer-executable components comprising a health component 120, a manager component 122, and an application layer signaling protocol component such as redirect component 124. In the embodiment of FIG. 1, these components are associated with the manager process 104. The health component 120 determines preference attributes, recycle factors, or other values for the worker processes 106 accessible to the UM server 102. The preference attributes for each of the worker processes 106 may include, for example, user-defined preferences, administrator-defined preferences, health status, load status, resource status, availability, and/or geographic location of the computing device executing the worker process 106.

The manager component 122 maintains an ordered list of the worker processes 106 based on the preference attributes determined by the health component 120. In one example, the ordered list represents the order in which the worker processes 106 are selected by the manager process 104 to handle incoming calls. The ordered list is independent of the connection parameters associated with each of the plurality of worker processes 106. The application layer signaling protocol component receives a call invitation from a caller and redirects the caller to one of the worker processes 106 based on the ordered list from the manager component 122 prior to receiving media content from the caller. The caller proceeds to establish a call with the worker process 106 via the connection parameters associated with the worker processes 106. In one embodiment, the application layer signaling protocol component executes during a signaling stage of the application layer signaling protocol (e.g., prior to receiving media content from the caller via the call). In one example, the manager process 104 monitors the number of calls made to each worker process 106.

In one example, when the manager process 104 receives an SIP NVITE call invitation message (e.g., at port 5060 of the UM server 102) from a caller via the media gateway 108, the manager process 104 determines whether there are any healthy worker processes 106 to receive the call. For example, the manager process 104 determines the preference attributes for each of the worker processes 106 and selects one of the worker processes 106 based on the determined preference attributes. In this example, the manager process 104 is associated with the application program executing the application layer signaling protocol (e.g., SIP) on the UM server 102. The manager process 104 identifies the active worker process 106 and issues the REDIRECT (e.g., SIP 302 message), while the low-level TCP/UDP driver stack on the UM server 102 determines the port number (e.g., 5061 in this example) associated with the active worker process 106. The REDIRECT mechanism effectively asks the media gateway 108 to send a new SIP INVITE for that call to, for example, port 5061 on the UM server 102 where the active worker process 106 is listening. The call continues between the media gateway 108 and the worker process 106.

The receipt of the SIP invite and the identification of the active worker process 106 occur during a signaling stage of the signaling protocol (e.g., SIP). The health monitoring may occur during or prior to the signaling stage. In this manner, the operation of the manager process 104 to identify and select the worker process 106 occurs independent of the connection parameters associated with the worker processes 106.

In one embodiment of the invention, a general purpose computing device such as a computer is suitable for use as the UM server 102. The computer typically has at least some form of computer readable media. Computer readable media, which include both volatile and nonvolatile media, removable and non-removable media, may be any available medium that may be accessed by the computer. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by the computer. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

Although described in connection with an exemplary computing system environment, including the computer, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

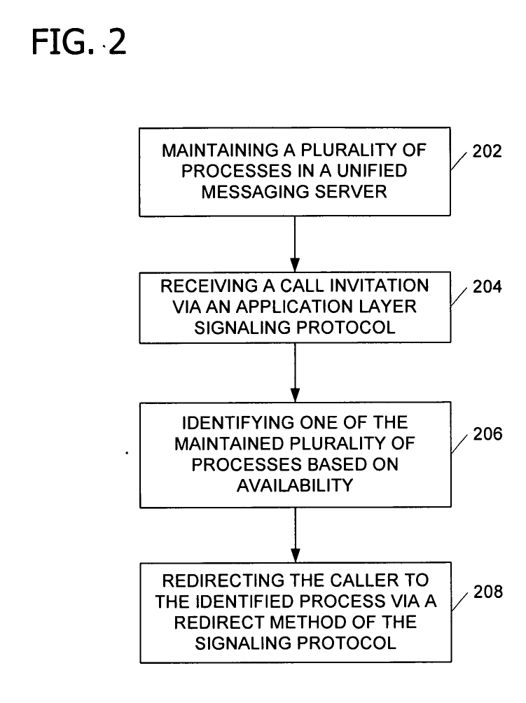

Referring next to FIG. 2, a flow chart illustrates operation of the UM server. A manager process in the UM server maintains a plurality of processes at 202. Each of the plurality of processes has connection parameters associated therewith for communication with a plurality of callers. The manager process receives a call from one of the plurality of callers via an application layer signaling protocol at 204 and identifies an active process based on availability of the maintained plurality of processes at 206. The manager process redirects the call to the identified active process via a redirect method of the application layer signaling protocol at 208. The redirection occurs at the call signaling stage.

In one embodiment, one or more computer-readable media have computer-executable instructions for performing the method illustrated in FIG. 2. In one embodiment, a processor is configured to execute the computer-executable instructions.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices. In operation, the computer executes computer-executable instructions such as those illustrated in the figures to implement aspects of the invention.

In one embodiment, the figures and description herein constitute exemplary means for implementing fault tolerant unified messaging via process recycling using the signaling protocol and exemplary means for monitoring the health of the plurality of worker processes.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. In a unified messaging system, a method comprising:
maintaining a plurality of processes, each of the plurality of processes having connection parameters associated therewith for communication with a plurality of callers;
receiving, from one of the plurality of callers, a call invitation based on an application layer signaling protocol;
identifying one of the maintained plurality of processes based on one or more recycle factors; and
redirecting said one of the callers to the identified one of the maintained plurality of processes via a redirect method of the signaling protocol, wherein said receiving and said redirecting occur during a signaling stage of the signaling protocol, and wherein said one of the callers proceeds to establish a call with the identified one of the maintained plurality of processes via the connection parameters associated with the identified one of the maintained plurality of processes.

2. The method of claim 1, wherein the recycle factors comprise one or more of the following: health of each of the processes, load status of each of the processes, resource status, user-defined preferences, administrator-defined preferences, availability, and geographic location of each of the processes.

3. The method of claim 1, wherein the application layer signaling protocol comprises the Session Initiation Protocol.

4. The method of claim 1, wherein the connection parameters comprise one or more of the following: port, network address, socket number, and machine name.

5. The method of claim 1, wherein said redirecting occurs independent of the connection parameters associated with the identified one of the plurality of processes,

6. The method of claim 1, wherein the caller comprises one or more of the following: a user, a client, an application program, and an operating system.

7. The method of claim 1, wherein said redirecting occurs prior to receiving media content from the caller via the call.

8. The method of claim 1, wherein one or more computer-readable media have computer-executable instructions for performing the method of claim 1.

9. A system for fault tolerant unified messaging comprising:
a memory area for storing a list of worker processes, each of the plurality of worker processes having connection parameters associated therewith; and
a processor configured to execute computer-executable instructions for:
receiving a call invitation from a caller via a media gateway based on an application layer signaling protocol;
determining preference attributes for each of the worker processes in the list of worker processes stored in the memory area;
selecting one of the worker processes from the list stored in the memory area, based on the determined preference attributes;
identifying, to the media gateway, the selected one of the worker processes via a redirect method of the signaling protocol, wherein said receiving and said identifying occur during a signaling stage of the signaling protocol, and wherein the caller proceeds to communicate with the selected one of the worker processes via the connection parameters.

10. The system of claim 9, wherein the application layer signaling protocol comprises the Session Initiation Protocol (SIP).

11. The system of claim 9, wherein said identifying occurs independent of the connection parameters associated with the selected one of the worker processes.

12. The system of claim 9, further comprising means for implementing fault tolerant unified messaging via process recycling using the signaling protocol.

13. The system of claim 9, further comprising means for monitoring the health of the worker processes.

14. One or more computer-readable media having computer-executable components in a unified messaging application program for fault tolerant unified messaging, said components comprising:
a health component for determining preference attributes for a plurality of worker processes accessible to the unified messaging application program;
a manager component for maintaining an ordered list of the plurality of worker processes based on the preference attributes determined by the health component, said ordered list being independent of connection parameters associated with each of the plurality of worker processes; and
an application layer signaling protocol component for receiving a call invitation from a caller and redirecting the caller to one of the worker processes based on the ordered list from the manager component prior to receiving media content from the caller, wherein the caller proceeds to establish a call with said one of the worker processes via the connection parameters associated with said one of the worker processes.

15. The computer-readable media of claim 14, wherein the application layer signaling protocol component implements an application layer signaling protocol, and wherein the application layer signaling protocol component executes during a signaling stage of the application layer signaling protocol.

16. The computer-readable media of claim 14, wherein the unified messaging application server executes on a first computing device, and wherein one or more of the worker processes execute on a second computing device.
